(19) United States
(12) Patent Application Publication
(10) Pub. No.: US 2019/0321802 A1
(43) Pub. Date: Oct. 24, 2019

(54) ABSORBENT AND PERMEABLE CERAMIC, AND PREPARATION METHOD AND APPLICATION THEREOF

(71) Applicant: Linyu SHI, Jingdezhen City (CN)

(72) Inventors: Linyu SHI, Jingdezhen City (CN); Zhijun PENG, Linxiang City (CN); Xiujuan HUANG, Ji'an City (CN)

(21) Appl. No.: 15/961,108

(22) Filed: Apr. 24, 2018

(51) Int. Cl. B01J 20/10; B01J 20/08; B01J 20/30; C04B 35/14; C04B 35/10

(52) U.S. Cl. CPC B01J 20/10; B01J 20/08; B01J 20/3078; C04B 2235/606; C04B 35/10; C04B 2235/3218; C04B 2235/3418; C04B 35/14

(57) ABSTRACT

The invention discloses an absorbent and permeable ceramic and a preparation method and application thereof. The absorbent and permeable ceramic is prepared by the steps of: adding water to the following raw components in parts by weight: 1-5 parts of bauxite, 1-3 parts of quartz, 1-3 parts of black soil and 1 part of crude pottery and then kneading evenly; flapping and shaping the evenly kneaded mixed mud; drying the shaped mixed mud under room temperature, biscuiting, supplementing water to wipe out the dust on the surfaces of the mixed mud, and sintering the mixed mud in a redox atmosphere in a kiln to obtain the absorbent and permeable ceramic, wherein the sintering temperature is in the range of 1280-1350° C. and the sintering duration is in the range of 10-12 h. The absorbent and permeable ceramic can be used as an absorbent and permeable ceramic tea tray, the tea tray has the characteristics of being absolutely free of decolorization, blistering or mildewing and does not crack due to high-temperature tea water, and it is convenient to clean residual tea water quickly.

### TECHNICAL FIELD

The present invention pertains to the field of ceramic tea sets, particularly relates to an absorbent and permeable ceramic and a preparation method and application thereof.

### BACKGROUND

The existing ceramic tea trays consist of two types: planar tea trays and spatial tea trays for water storage.

The defect of the planar tea trays is that it is liable to drip or splash tea water on the tea tray during tea making, which draws attention to wipe away the tea water on the tea tray now and then using a tea towel, and it is liable to wet a tea table, which is very cumbersome and time-consuming to clean and tidy.

The spatial tea trays have holes that allow water to flow into the tea trays, thus they have fewer defects than the planar tea trays. However, there are still deficiencies: when water flows into the holes, it does not flow into an interior of the tea trays totally; moreover, there will be residual tea water which cannot be poured out and drained due to the fabrication process and structure and principle of this type of tea tray, and it will stink over time. Other materials of tea trays of the prior art, including bamboo, solid wood, and stone, all solve the problem of cleaning of tea water after drinking tea by storing water and draining with fine water pipes. Among them, after submerged for a long time, bamboo is liable to mildew, blister and crack, while solid wood is liable to change color, mildew, swell, and stone is liable to crack suddenly in boiling water during tea making.

### SUMMARY

The object of the present invention is to provide an absorbent and permeable ceramic.

Another object of the present invention is to provide a preparation method for the absorbent and permeable ceramic described above.

Yet another object of the present invention is to provide an application of the above-mentioned absorbent and permeable ceramic as tea trays, that is, to provide an absorbent and permeable ceramic tea tray, which aims to solve the various deficiencies in the water storage and drainage process of tea trays described in the above background.

The present invention is embodied as an absorbent and permeable ceramic comprising the following components in parts by weight:

1-5 parts of bauxite,

1-3 parts of quartz,

1-3 parts of black soil and

1 part of crude pottery.

Preferably, the ceramic comprises the following components in parts by weight:

1 part of bauxite,

2 parts of quartz,

1 part of black soil and

1 part of crude pottery.

Preferably, the black soil is Fujian black soil; the bauxite is Henan bauxite; and the quartz is Lianyungang quartz.

Preferably, the crude pottery is Jingdezhen raw ore crude pottery mud.

The present invention further provides a preparation method for an absorbent and permeable ceramic wherein the method comprising the steps of:

(1) adding water to the following raw components in parts by weight: 1-5 parts of bauxite, 1-3 parts of quartz, 1-3 parts of black soil and 1 part of crude pottery, and then kneading evenly, flapping and shaping the evenly kneaded mixed mud;

(2) drying the mixed mud shaped in the step (1) under room temperature, biscuiting, supplementing water to wipe out dust on surfaces of the mixed mud, and sintering the mixed mud in a redox atmosphere in a kiln to obtain the absorbent and permeable ceramic, where the sintering temperature is in the range of 1280-1350° C. and the sintering duration is in the range of 10-12 h.

Preferably, in the step (1), the weight ratio of the bauxite, the quartz, the black soil and the crude pottery is 1:2:1:1.

Preferably, in the step (1), the bauxite is Henan bauxite, the quartz is Lianyungang quartz, the black soil is Fujian black soil, and the crude pottery is Jingdezhen raw ore crude pottery mud.

Preferably, in the step (1), the kneading evenly is to knead the raw components evenly using the Chrysanthemum kneading of Chinese traditional pottery technique to merge them together.

Preferably, in the step (2), the biscuiting temperature is in the range of 680-800° C. and the biscuiting duration is in the range of 4-6 h.

Preferably, the sintering temperature is 1320° C. and the sintering time is 11 h.

The present invention further provides an application of the above-mentioned absorbent and permeable ceramic as tea trays, wherein a preparation method for the absorbent and permeable ceramic comprises the steps of:

(1) adding water to the following raw components in parts by weight: 1-5 parts of bauxite, 1-3 parts of quartz, 1-3 parts of black soil and 1 part of crude pottery, and then kneading evenly, flapping and shaping the evenly kneaded mixed mud;

(2) drying the mixed mud shaped in the step (1) under room temperature, biscuiting, supplementing water to wipe out dust on surfaces of the mixed mud, and sintering the mixed mud in a redox atmosphere in a kiln to obtain the absorbent and permeable ceramic, wherein the sintering temperature is in the range of 1280-1350° C. and the sintering duration is in the range of 10-12 h.

The present invention overcomes the deficiencies of the prior art and provides an absorbent and permeable ceramic and a preparation method and application thereof. The absorbent and permeable ceramic of the present invention is prepared by recombining a plurality of ceramic raw material elements according to a certain proportion, and then sintering at a high temperature. The absorbent and permeable ceramic has an extremely strong water absorption ability which makes it suitable for tea trays. Compared to the disadvantages and deficiencies of the prior art, the present invention has the following beneficial effects:

(1) The raw material of the absorbent and permeable ceramic of the present invention is simple and readily to obtain, and the preparation method is simple, resulting in the low cost of manufacture;

(2) The absorbent and permeable ceramic of the present invention is used as an absorbent and permeable ceramic tea tray to quickly absorb the water that dripped or splashed on the surface of the tea tray during tea making process, and does not leak water to tea table; an absorbent and permeable ceramic tea tray can be continuously used for many times, and can be reused after drying treatment;

(3) The absorbent and permeable ceramic of the present invention is used as an absorbent and permeable ceramic tea tray, and have the characteristics of being absolutely free of decolorization, blistering or mildewing, and does not crack due to high-temperature tea water, and it is convenient to clean residual tea water quickly. Moreover, it may become glossier after using for a long time. It is practical, beautiful and harmless to the human body during use.

### DETAILED DESCRIPTION OF THE EMBODIMENTS

In order to make the purposes, technical solutions, and advantages of the present invention clearer, the present invention will be further described in detail with reference to the following embodiments. It should be understood that the specific embodiments described herein are only used to elucidate the present invention and are not intended to limit the present invention.

### Embodiment 1

(1) adding water to the following raw components: Henan bauxite of 100 g, Lianyungang quartz of 300 g, Fujian black soil of 100 g and Jingdezhen raw ore crude pottery mud of 100 g and then kneading evenly using the Chrysanthemum kneading of Chinese traditional pottery technique to merge them together, flapping and shaping the evenly kneaded mixed mud;

(2) drying the shaped mixed mud in step (1) under room temperature, biscuiting at 680° C. for 4 h, supplementing water to wipe out the dust on the surface of the mixed mud, and sintering the mixed mud in a redox atmosphere in a kiln at 1280° C. for 10 h to obtain the absorbent seepage ceramic.

After that a fine combined granular water-absorbing porcelain particles is formed inside the whole absorbent and permeable ceramic, which can quickly absorb water into its internal structure.

### Embodiment 2

(1) adding water to the following raw components: bauxite of 500 g, quartz of 100 g, black soil of 300 g and crude pottery mud of 100 g and then kneading evenly using the Chrysanthemum kneading of Chinese traditional pottery technique to merge them together, flapping and shaping the evenly kneaded mixed mud;

(2) drying the shaped mixed mud in step (1) under room temperature, biscuiting at 800° C. for 6 h, supplementing water to wipe out the dust on the surface of the mixed mud, and sintering the mixed mud in a redox atmosphere in a kiln at 1350° C. for 12 h to obtain the absorbent seepage ceramic.

After that a fine combined granular water-absorbing porcelain particles is formed inside the whole absorbent and permeable ceramic, which can quickly absorb water into its internal structure.

### Embodiment 3

(1) adding water to the following raw components: Henan bauxite of 100 g, Lianyungang quartz of 200 g, Fujian black soil of 100 g and Jingdezhen raw ore crude pottery mud of 100 g and then kneading evenly using the Chrysanthemum kneading of Chinese traditional pottery technique to merge them together, flapping and shaping the evenly kneaded mixed mud;

(2) drying the shaped mixed mud in step (1) under room temperature, biscuiting at 700° C. for 5 h, supplementing water to wipe out the dust on the surface of the mixed mud, and sintering the mixed mud in a redox atmosphere in a kiln at 1320° C. for 11 h to obtain the absorbent seepage ceramic.

After that a fine combined granular water-absorbing porcelain particles is formed inside the whole absorbent and permeable ceramic, which can quickly absorb water into its internal structure.

The foregoing descriptions are merely preferred embodiments of the present invention and are not intended to limit the present invention. Any modification, equivalent replacement and improvement made within the spirit and principle of the present invention shall be included in the protection scope of the present invention.

What is claimed is:

1. An absorbent and permeable ceramic, wherein the absorbent seepage ceramic comprising the following components in parts by weight:
1-5 parts of bauxite,
1-3 parts of quartz,
1-3 parts of black soil and
1 part of crude pottery.

2. The absorbent and permeable ceramic of claim 1, wherein the absorbent seepage ceramic comprising the following components in parts by mass:
1 part of bauxite,
2 parts of quartz,
1 part of black soil and
1 part of crude pottery.

3. The absorbent and permeable ceramic of claim 2, wherein the black soil is Fujian black soil, the bauxite is Henan bauxite, and the quartz is Lianyungang quartz.

4. The absorbent and permeable ceramic of claim 3, wherein the crude pottery is Jingdezhen raw ore crude pottery mud.

5. A preparation method for absorbent and permeable ceramic, wherein the method comprising the following steps:
(1) adding water to the following raw components in parts by weight: 1-5 parts of bauxite, 1-3 parts of quartz, 1-3 parts of black soil and 1 part of crude pottery and then kneading evenly, flapping and shaping the evenly kneaded mixed mud;
(2) drying the mixed mud shaped in the step (1) under room temperature, biscuiting, supplementing water to wipe out dust on surfaces of the mixed mud, and sintering the mixed mud in a redox atmosphere in a kiln to obtain the absorbent and permeable ceramic, where the sintering temperature is in the range of 1280-1350° C. and the sintering duration is in the range of 10-12 h.

6. The preparation method for absorbent and permeable ceramic of claim 5, wherein in the step (1), the weight ratio of the bauxite, the quartz, the black soil and the crude pottery is 1:2:1:1.

7. The preparation method for absorbent and permeable ceramic of claim 6, wherein in the step (1), the bauxite is Henan bauxite, the quartz is Lianyungang quartz, the black soil is Fujian black soil, and the crude pottery is Jingdezhen raw ore crude pottery mud.

8. The preparation method for absorbent and permeable ceramic of claim 7, wherein in the step (1), the kneading evenly is to knead the raw components evenly using the Chrysanthemum kneading of Chinese traditional pottery technique to merge them together.

9. The preparation method for absorbent and permeable ceramic according to claim 8, wherein in the step (2), the biscuiting temperature is in the range of 680-800° C. and the bisque firing duration is in the range of 4-6 h.
